(19) United States
(12) Patent Application Publication
(10) Pub. No.: US 2007/0181512 A1
(43) Pub. Date: Aug. 9, 2007

(54) Seat of a compound draft-paper rack

(76) Inventor: Shao-Chieh Ting, Banchiau City (TW)

Correspondence Address: TROXELL LAW OFFICE PLLC, SUITE 1404, 5205 LEESBURG PIKE, FALLS CHURCH, VA, 22041, US

(21) Appl. No.: 11/346,360

(22) Filed: Feb. 3, 2006

(51) Int. Cl. B42F 17/00

(52) U.S. Cl. 211/10

(57) ABSTRACT

A multi-function draft-paper rack, which is specifically a seat of draft-paper rack having a function of combining documents, is provided. The seat of draft-paper rack is primarily composed of a main body whose top is provided with a plurality of collection slots for collecting CDs, emplacing paper clamps, collecting scratch papers, and holding pens respectively. In addition, the main body can also serve as a paper-weight. Accordingly, the seat of draft-paper rack is provided with an effect of combining documents. Furthermore, an extension pad which can be extended backward is located at a rear side of the main body, in order to prevent the main body from tilting backward.

### BACKGROUND OF THE INVENTION

(a) Field of the Invention

The present invention relates to a seat design of a compound draft-paper rack on a desk, and more particularly to a draft-paper rack which can combine office documents.

(b) Description of the Prior Art

A lot of documents, CDs (compact disc), or scratch papers are usually required to be put on an ordinary office desk, a family study desk, or a computer desk, for facilitating work. However, when there are too many documents, CDs, or scratch papers, the entire desktop would be rather disorder or even damaged. Therefore, different kinds of office tools are used to collect the documents, CDs, or scratch papers, separately. For example, a clamp will be mostly used to collect the documents, a CD box or a bag will be used to collect the CDs, and a box will be used to hold the scratch papers.

However, as an original space of the ordinary office desk, study desk, or computer desk is rather limited, if the clamp, CD box, and box are used on the desktop to collect the documents, CDs, or scratch papers, the original space on the desktop will also be occupied, thereby reducing an office space, which is a common problem.

In addition, upon operating a computer on the computer desk, as a data collection or document processing are often required to proceed, most of the document processing method is to put the documents on the computer desk, or to use a clamp to clip the documents beside the computer, so as to quickly browse data on the documents, and to quickly enter the data on the documents into the computer; however, the documents are often unable to be emplaced due to a reduction of desktop space during work, thereby affecting a working schedule.

Moreover, when the important documents are emplaced on the desktop, a paper-weight will be mostly used to press on the documents, in order to firmly hold the documents on the desktop through a weight of the paper-weight.

Although the aforementioned various kinds of collecting methods for office documents can be used to collect and emplace the documents, CDs, or scratch papers through different office tools, they are easy to reduce the desktop space, and also enable the desktop to appear disorder, thereby requiring improvement.

### SUMMARY OF THE INVENTION

The present invention comprises primarily a main body whose top is provided with a plurality of collection slots, for collecting CDs, emplacing clamps, collecting scratch papers, and holding pens. In addition, the main body can also be used as a paper-weight, so as to enable the seat of draft-paper rack to have an effect of integrating documents. An extension pad which can be extended backward is located at a rear of the main body, in order to prevent the main body from tilting backward.

The primary object of the present invention is to combine the CDs, clamps, scratch papers, and papers by the plurality of collection slots installed on the main body. In addition, the main body can also press on the documents on the desktop to serve as a paper-weight, so as to combine all kinds of office documents on the desktop, thereby saving a space of utilization on the desktop.

Moreover, the extension pad, which is located at the rear of the main body, can be extended at the rear side of the main body, so as to increase a supporting force of the main body upon being loaded, thereby preventing the main body from tilting or falling.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of compartments of the present invention.

FIG. 2 shows a cutaway view the present invention.

FIG. 3 shows a schematic view of an operating status of the present invention.

FIG. 4 shows a side view of an operating status of the present invention.

### DETAILED DESCRIPTION OF THE PREFERRED EMBODIMENTS

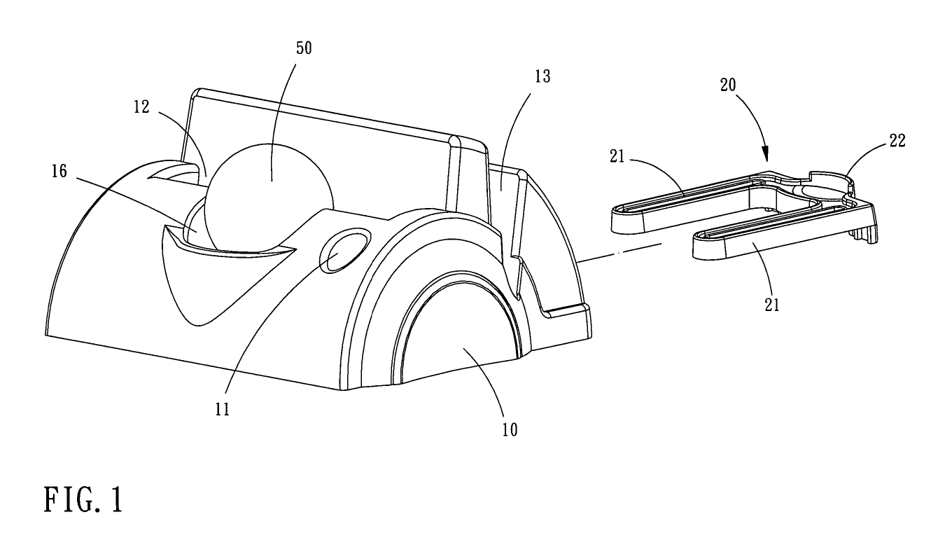

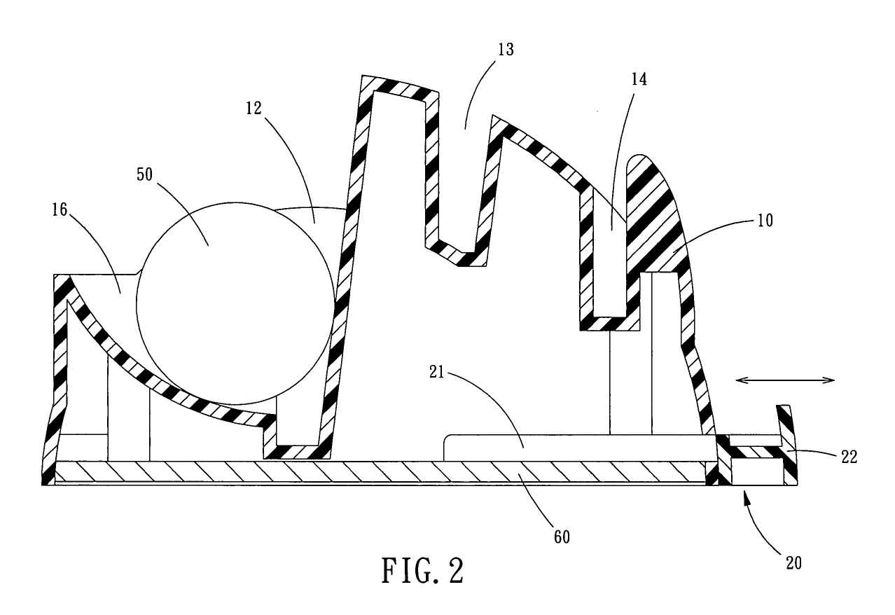

Referring to FIG. 1 and FIG. 2, the present invention comprises primarily a main body 10 whose top is provided with a plurality of collection slots including a first collection slot 11, a second collection slot 12, a third collection slot 13, and a fourth collection slot 14.

The first collection slot 11 is in a deep-hole shape, a guiding groove 16 is located in a front end of the second collection slot 12, wherein a ball 50 is emplaced in the guiding groove 16 and can be freely moving, two sides of the third collection slot 13 are in an open status, and the fourth collection slot 14 is in a concaved shape. In addition, a chassis 60 is installed in an interior of a bottom end of the main body 10, in order to increase a weight of the main body 10. At least one perforation 15 is located at a rear side of the main body 10, providing for an insertion of an extension pad 20 such that the extension pad 20 can be pulled back and forth at the rear of the main body 20.

An extension member 21 is further located in a front end of the extension pad 20, and a pulling member 22 is located at a tail end of the extension pad 20. The extension member 21 is passed through the perforation 15 at the rear of the main body 10, so as to pull the extension pad 20 back and forth at the rear of the main body 10, whereas the pulling member 22 is used to provide a user for pulling the extension pad 20.

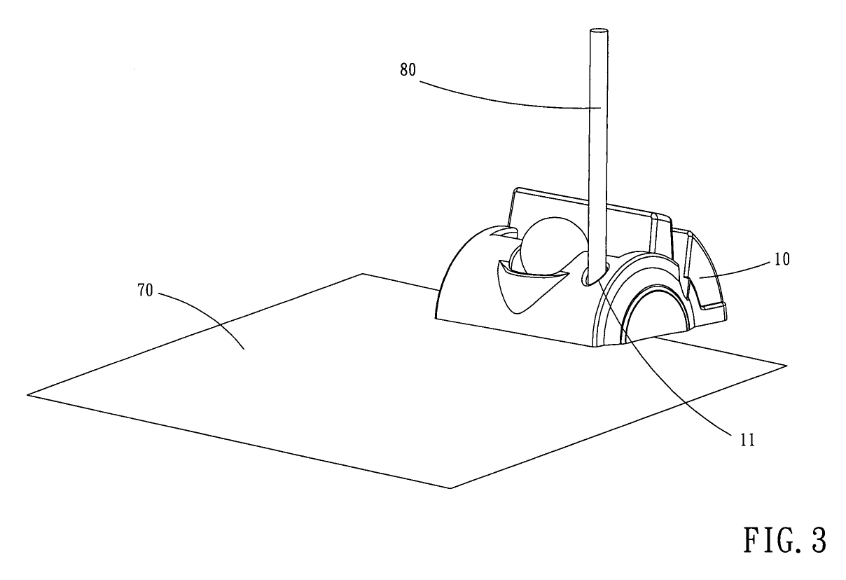

Referring to FIG. 3, when the main body 10 is put on a desktop, an effect of paper-weight can be formed on a document 70 through a weight of a chassis 30 by pressing the main body 10 on a top of the document 70, enabling the document 70 to be not easily fallen on a ground. In the mean time, a pen 80 can be collected through the first collection slot 11, so as to enable a user to quickly fetch the pen 80 in order to write on the document 70.

Referring to FIG. 2, as an interior of the guiding groove 16 of the second collection slot 12 is in a shape of slope with a front end higher than a rear end, the ball 50 will be rolling automatically toward a back side. Accordingly, scratch papers in the second collection slot 12 will be tightly pressed by the ball 50 (not shown in the drawing) by the effect that the ball 50 in the guiding groove 16 will be rolling toward a lower place. When a user withdraws a piece of scratch papers, the ball 50 will be rolling automatically, and tightly press against other scratch papers by its weight.

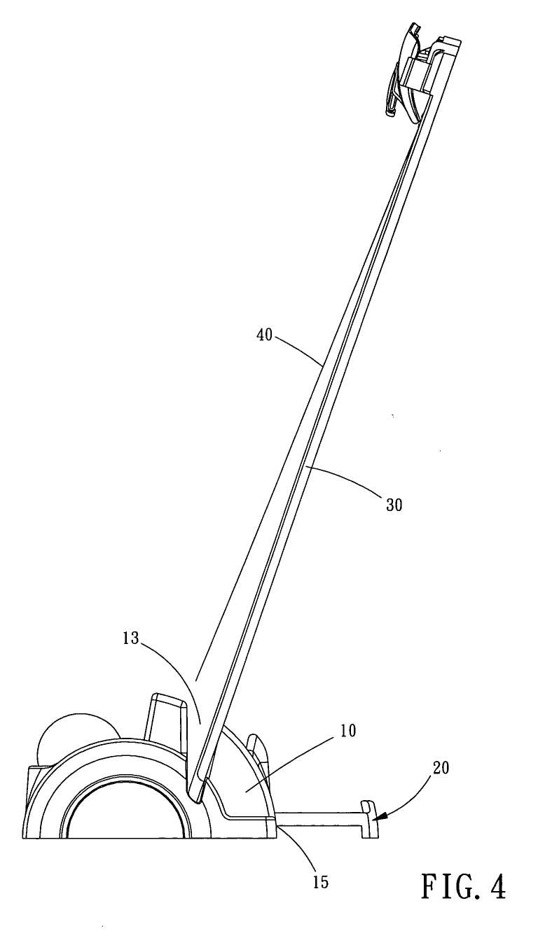

Referring to FIG. 4, when an object such as a book, a paper clamp, or a hand-writing pad is emplaced in the collection slot above the main body 10 (a paper clamp is used as an implementation), as the third collection slot 13 is located on the main body 10 at a position close to a rear side of the main body 10, and the paper clamp 30 is much higher than the main body 10, it is easy to cause a center of gravity to tilt backward when the paper clamp 30, when the paper clamp 30 clamps a document 40 or a book.

Accordingly, the extension pad 20 is extended toward a rear side of the main body 10 to increase a supporting force of the main body 10, and to maintain a center of gravity of loading in a center position of the main body 10, thereby preventing the main body 10 from tilting.

Moreover, as the fourth collection slot 14 is in a concaved shape, therefore, CDs can be emplaced in the fourth collection slot 14. As shown in FIG. 2, in addition to collecting the CDs, the CDs are not easy to glide off by a design of concaved shape, thereby achieving an effect of combining and collecting the CDs.

Accordingly, by a plurality of collection slots on the main body 10, along with a design of various shapes of the collection slots, a combination and collection of all kinds of office tools such as pens, scratch papers, and CDs can be performed by the collection slots.

In addition, the weight of main body 10 can be increased by the chassis 60 at a bottom end of the main body 10, and the main body 10 can serve as a paper-weight, such that the entire draft-paper rack can perform a collection of all kinds of office documents, thereby saving a space of utilization on the desktop.

Moreover, by a feature of pulling the extension pad 20 behind the main body 10, a supporting force of the main body 10 can be increased, and a center of gravity of the main body 10 can be kept at a center position, so as not to cause a falling.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A seat of a compound draft-paper rack primarily including a main body whose top is provided with a plurality of collection slots for collecting CDs, emplacing hand-writing pads, collecting scratch papers and holding pens respectively, along with the main body being used to serve as a paper-weight, such that the draft-paper rack can have an effect of combining documents; an extension pad which can be pulled back and forth being located at a rear side of the main body, so as to prevent the main body from tilting backward.

2. The seat of a compound draft-paper rack according to claim 1, wherein at least one perforation is located at a rear side of the main body, and an extension member which is inserted into the perforation being located in a front end of the extension pad.

3. The seat of a compound draft-paper rack according to claim 1, wherein a pulling member is located at a rear end of the extension pad.

4. The seat of a compound draft-paper rack according to claim 1, wherein a chassis is located in an interior at a bottom of the main body, in order to increase a weight of the main body.

5. The seat of a compound draft-paper rack according to claim 1, wherein the collection slots include a first collection slot in a deep-hole shape, a second collection slot whose front end is provided with a guiding groove, a third collection slot whose two sides are in an open shape, and a fourth collection slot in a concaved shape.

6. The seat of a compound draft-paper rack according to claim 5, wherein the interior of the guiding groove is in a shape of slope with a front end higher than the rear end.

7. The seat of a compound draft-paper rack according to claim 5, wherein a ball is emplaced in the guiding groove, so as to be freely moving in the guiding groove.
